(19) United States
(12) Patent Application Publication
(10) Pub. No.: US 2025/0128415 A1
(43) Pub. Date: Apr. 24, 2025

(54) Method and System for Generating a Path for a Robot Arm and a Tool Attached to the Robot Arm

(71) Applicant: OnRobot A/S, Odense SØ (DK)

(72) Inventors: Enrico Krog IVERSEN, Odense SØ (DK); Vilmos BESKID, Odense SØ (DK); Ákos TAR, Odense SØ (DK); József VERES, Odense SØ (DK); Himal KOOVERJEE, Odense SØ (DK)

(21) Appl. No.: 18/999,658

(22) Filed: Dec. 23, 2024

Related U.S. Application Data
(63) Continuation of application No. PCT/DK2023/050165, filed on Jun. 26, 2023.

(30) Foreign Application Priority Data
Jul. 6, 2022 (DK) PA 2022 00652

(51) Int. Cl. B25J 9/16

(52) U.S. Cl. CPC B25J 9/1664; B25J 9/1697

(57) ABSTRACT

A method for generating a path (P) of a tool attached to a robot arm is disclosed. The robot arm is placed in a workspace that can comprise obstacles. The robot arm is connected to a compute box that is configured to control the motion of the robot arm. The path (P) has a starting point (A) and an end point (B). The path (P) is composed of a plurality of sub-motions (d₁, d₂, d₃, . . . , d_{N-2}, d_{N-1}, d_{N}). The method comprises the step of creating the path (P) as a single consecutive motion, wherein the i-th sub-motion (dᵢ) is determined by an optimization process carried out on the basis of predefined characteristics of a) the previous sub motion (dᵢ₋₁); b) the workspace and its obstacles if any; c) the tool and d) the robot arm.

### CROSS-REFERENCE TO RELATED APPLICATIONS

This application is a continuation under 35 U.S.C. 111 of International Patent Application No. PCT/DK2023/050165, filed Jun. 26, 2023, which claims the benefit of and priority to Danish Application No. PA 2022 00652, filed Jul. 6, 2022, each of which is hereby incorporated by reference in its entirety.

### FIELD OF INVENTION

The present invention relates to a method and a control system for generating a path for a robot arm and a tool attached to the robot arm.

### BACKGROUND

Automating one or more parts of the production line is important for many companies. As an alternative to a traditional programmable robot, some companies will use a collaborative robot arm (also called a cobot). Cobots and other types of industrial robots can be a good solution because the technology is affordable, space-efficient, and excels at ease of use.

Robots are popular because they enable rapid replacement of skilled labor or expertise in case of scarcity of qualified employees or when production needs to be sped up. Cobots are designed to work alongside human colleagues on the production or assembly line, due to various safety features.

Programming of a robot is required prior to using it in a workspace setup. This programming is, however, time consuming and requires skilled personnel. Accordingly, it would be desirable to be able to provide a method and a system that is more user-friendly and thus is easier to program.

WO2021242215A1 discloses a method for generating a path for a robot arm to move along with a tool attached to the robot arm. The method, however, only considers the robot and obstacles. Even though the method can do path planning, e.g., by creating a map and only taking into consideration the robot, the method does not provide information about what the robot and the tool need to do or how to respond to the elements in the cell (e.g., an infeed sensor). Accordingly, it would be desirable to have an alternative to the prior art.

U.S. Pat. No. 20,210,379758 A1 discloses an intelligent robotic learning system that obtains environmental data through sensors. The system selects a skill model based on these data. The system generates a plan for executing the skill, involving movements of its components. The system executes the plan and updates its understanding of the environment using sensor feedback. The solution does not require a robot to be pre-programmed with manipulation skills. The solution, however, is based on a learning process to be carried out. Since the learning process is time consuming and introduces uncertainty, it would be desirable to be able to provide a solution that allows a user to set up and use the control system/method right away without carrying out a learning process.

U.S. Pat. No. 10,723,025 B2 discloses a computer-implemented method for selecting a robotic tool path for a manufacturing processing system to execute a material processing sequence in three-dimensional space. The method comprises providing to a computer a computer-readable product including robotic system data associated with physical parameters of a robotic tool handling system and workpiece data for a workpiece to be processed by the material processing system. The workpiece data relate to a processing path of a tool connected to the robotic tool handling system along the workpiece. A start point and an end point of the processing path are generated, along with a plurality of possible robotic tool paths to be performed to move the tool along the processing path between the start point and the end point. Based on the robotic system data and/or the workpiece data, the method identifies one or more obstacles, or an absence of obstacles, associated with the robotic tool paths. The method compares robotic tool paths based on a predetermined robotic parameter to be controlled as the tool moves from the start point to the end point and based on the identified obstacles. The method determines feasible tool paths, between the start point and the end point that avoid the obstacles, that can be obtained by adjusting the predetermined robotic parameter. This solution does not address robot motion planning, and its challenges, throughout the entire application, such as when the workpiece is absent or after the processing task is completed, for example, when moving to the infeed to pick up a new raw part or placing the finished part.

Without application knowledge, even a skilled operator would struggle to determine how to generate the appropriate path. For example, welding along a square path versus gluing on the same path demands different robot motions.

Thus, it is an objective to provide a method and a system which reduce or even eliminate the above-mentioned disadvantages of the prior art.

### BRIEF DESCRIPTION

A method according to the present disclosure is a method for generating a path for a robot arm with a tool attached to the robot arm, wherein the tool is arranged to handle or process an object, wherein the robot arm is placed in a workspace that can comprise one or more obstacles, wherein the robot arm is connected to a control unit that is configured to control the motion of the robot arm, wherein the path has a starting point and an end point, wherein the path is composed of a plurality of sub-motions, wherein the method comprises the following steps:
letting a user select or auto detecting a relevant application from a list of predefined applications each having predefined characteristics;
creating the path as a single consecutive motion, wherein the path is a collision free path, wherein the i-th sub-motion is determined by an optimization process carried out on the basis of:
a) the previous sub motion;
b) the workspace and its obstacles if any;
c) the configuration of the robot arm;
d) the robot arm;
   wherein the i-th sub-motion is determined by an optimization process carried out on the basis of:
the configuration of the tool, wherein the configuration includes the orientation, position and geometry of the tool, wherein the configuration of the tool is being monitored; and
the predefined characteristics of the selected application.

Hereby, it is possible to generate the path in an easier and more user-friendly manner than in the prior art. Accordingly, it is possible to reduce the programming time. Moreover, the programming does not require skilled personnel as in the prior art.

The method is configured to generate a path for a robot arm with a tool attached to the robot arm. Accordingly, the path of a robot arm having a tool attached to its distal end is generated.

In an embodiment, the tool is arranged to handle an object. The tool may, by way of example, be a two-finger gripper, a three-finger gripper or a vacuum gripper.

In an embodiment, the tool is arranged to process an object. The tool may be a sander or a screwdriver.

The robot arm is placed in a workspace that can comprise one or more obstacles. The obstacles may be defined as any structure that prevents or restricts the motion of the robot arm and the tool.

The robot arm is connected to a control unit that is configured to control the motion of the robot arm. The control unit may be connected to or integrated within the robot arm.

In an embodiment, the control unit is a compute box being a separate box that is configured to be electrically connected to the robot arm.

In an embodiment, the control unit is an integrated part of the robot arm or a control structure of the robot arm.

The path has a starting point and an end point. In an embodiment, the starting point differs from the end point. In another embodiment, the starting point corresponds to the end point.

The path is composed by a plurality of sub-motions. The method comprises the step of letting a user select or auto detecting a relevant application from a list of predefined applications each having predefined characteristics. The list may, e.g., comprise a palletizing application and a machine tending application. In an embodiment, the list comprises a machine tending application for use with, for example, CNC-machines, lathes or milling machines. When the user selects a relevant application from a list of predefined applications, then necessary information related to the application is predefined. Accordingly, the subsequent programming can be significantly simplified because all predefined information and restrictions have already been pre-programmed.

The path is a collision free path. Accordingly, the path is generated in such a manner that no collision occurs for either the robot arm or the tool.

The method comprises the step of creating the path as a single consecutive motion, wherein the i-th sub-motion is determined by an optimization process carried out on the basis of
a) the previous sub motion;
b) the workspace and its obstacles if any;
   wherein the i-th sub-motion is determined by an optimization process carried out on the basis of:
the predefined characteristics of the tool;
the configuration of the tool and the robot arm, wherein the configuration includes the orientation, position and geometry of the tool, wherein the configuration of the tool is being monitored; and
the predefined characteristics of the selected application.

A single consecutive motion means that the path is created so it results in a continuous motion.

The predefined characteristics of the selected application may include any relevant restriction or enablement associated with the application. If the application is palletizing, the orientation of the boxes should be kept within a range that ensures the objects in the boxes do not fall out. In an embodiment, the orientation of the robot tool and the attached boxes is kept vertical to ensure boxes do not fall out. Accordingly, the boxes cannot be turned upside down.

In an embodiment, the method comprises the step of letting a user select a relevant application from a list of predefined applications each having predefined characteristics.

In an embodiment, the method comprises the step of auto detecting a relevant application from a list of predefined applications each having predefined characteristics. Auto detecting is possible if a predefined known type of hardware can be detected automatically. The detection can be accomplished when the hardware is connected via a wired connection to the control unit or another unit that is connected to the control unit.

The previous sub motion is taken into consideration. Accordingly, if the motion is stopped, the motion can be continued from the position at which the robot arm stopped.

The workspace and its obstacles if any are taken into account when the path is generated. Accordingly, the method ensures that any restrictions defined on the basis of the geometry, size, position and orientation of any structure in the workspace is taken into consideration. In an embodiment, the obstacles are defined by using a 3D model.

The configuration of the tool and the robot arm is taken into account when generating the path. The configuration includes the orientation, position and geometry of the tool, wherein the configuration of the tool is being monitored. Accordingly, if the configuration of a tool is changed over time while moving the robot arm, this is taken into account when generating the path. Moreover, the change of the joint angles (the angle between adjacent segments) of the robot is taken into account when generating the collision free path. Hereby, self-collision can be avoided.

In an embodiment, the application setup is carried out as the last step before the path is generated (through generation of a program). This is an advantage because it enables amending the application type/setup without changing hardware and work cell.

In an embodiment, a user provides user input (e.g., during selection of hardware and definition of obstacles). In an embodiment, the method comprises the step of providing autodetection of hardware and obstacles.

In an embodiment, the method comprises the step of defining a number of two-or three-dimensional zones, including one or more safety zones, in which the speed of the robot arm and/or the tool is reduced if an operator approaches a danger zone.

In an embodiment, the method comprises the step of defining a number of two-or three-dimensional safety zones by using the control unit and manually selecting the position, size, geometry and orientation of a number of two-or three-dimensional safety zones.

In an embodiment, the method generates a completed robot program with a path for a robot arm to move along.

In an embodiment, the method generates the robot program in dependency of sensory input conditions.

In an embodiment, the method generates the robot program in dependency of peripheral machine actuation statements.

In an embodiment, the method takes into consideration the state of the workpiece (present or not, to be gripped or placed).

In an embodiment, the i-th sub-motion is determined by an optimization process carried out on the basis of:
the configuration of the tool, wherein the configuration includes the orientation, position and geometry of the tool, and the state (if a workpiece is present or not), wherein the configuration of the tool is being monitored; and
the predefined characteristics of the selected application.

In an embodiment, the method comprises the step of carrying out a change of the configuration of the tool while the robot arm is moved, e.g., in dependency of one or more sensor signals and/or camera signals.

Carrying out a change of the configuration of the tool may include preparing the tool for an upcoming tool action.

In an embodiment, the tool is a gripper, and the method comprises the step of opening the gripper so that it is ready to grip an object while moving the gripper towards an object to be gripped using the gripper. This may be done when the position of the object is known or detected, e.g., by a sensor or a camera.

In an embodiment, the method comprises the step of:
a) determining the position and/or configuration of an object or structure in the workspace; and
b) providing an adaptive control by determining the path in dependency of or on the basis of the position and/or configuration of an object or structure.

If a robot is feeding objects to two pallets in an alternating manner and suddenly one of the pallets is removed, the robot will continue to feed objects to the remaining pallet. Alternating pallets means that the robot completes two pallets A and B sequentially.

In an embodiment, the method carries out real time (online) data collection and data processing, wherein the data collection includes determination of position data of objects and structures.

In an embodiment, the method comprises the step of saving historical data of the motion of the robot arm, the tool and the objects handled/processed by the tool so that the position of the objects relative to the robot arm are saved.

Hereby, it is possible to move the robot and corresponding structures (e.g., pallets), for example, to another location and continue the process (e.g., feeding objects to a pallet).

In an embodiment, the method comprises an initial hardware in a robotic cell setup step that is carried out by a user before carrying out the optimization process, wherein the user selects one or more pieces of hardware including the robot arm during the setup step.

By the term robotic cell (or cell) is meant a cell that contains the components required for the robot, or multiple robots, to perform tasks, e.g., on an assembly line. These tools may include sensors, end effectors, such as grippers, and part feeding mechanisms.

In an embodiment, the initial hardware setup step includes automatic detection of pieces of hardware including the robot arm.

In an embodiment, the initial hardware setup step includes automatic detection of pieces of hardware including the robot arm, wherein the user must confirm the automatic detections.

In an embodiment, the initial hardware setup step includes the steps of:
a) automatically detecting the one or more pieces of hardware that is/are wired or wirelessly connected to the control unit;
b) presenting the detected hardware visually for the user; and
c) letting the user confirm the automatically detected pieces of hardware.

In an embodiment, the initial hardware setup step includes the steps of:
a) automatically detecting the one or more pieces of hardware that is/are wired or wirelessly connected to the control unit;
b) presenting the detected hardware visually for the user;
c) letting the user confirm the automatically detected pieces of hardware; and
d) letting the user select additional pieces of hardware.

In an embodiment, the hardware may be physical objects that cannot be automatically detected.

In an embodiment, the hardware may be sensors to detect the presence of pallets or other structures.

In an embodiment, the initial hardware setup step includes the steps of:
a) automatically detecting the one or more pieces of hardware that is/are wired or wirelessly connected to the control unit;
b) presenting the detected hardware visually for the user;
c) letting the user confirm the automatically detected pieces of hardware and
d) letting the user select additional pieces of hardware from a predefined list.

By using a predefined list, it is possible to provide all required information about the hardware in advance. Hereby, it is possible to prepare sequences of software corresponding to predefined hardware in advance. These sequences can then be used in order to ease and shorten the required programming time.

In an embodiment, the method comprises an initial workspace setup step that is carried out by the user before the method is carrying out the optimization process, wherein the workspace setup step comprises the steps of:
a) selecting the position and orientation of the selected obstacles in the workspace setup step;
b) inserting the selected pieces of hardware into the workspace; and
c) presenting the selected pieces of hardware visually for the user.

Some of the obstacles may be automatically identified (e.g., by the sensors). The robot arm may be automatically detected and inserted in the workspace. In a similar manner, the tool and other structures may be automatically detected and inserted in the workspace. One or more sensors may be used to detect the presence and/or position and/or size and/or orientation and/or geometry of tools, structures or obstacles.

In an embodiment, the method comprises an initial obstacle setup step that is carried out by a user before carrying out the optimization process, wherein the obstacle setup step comprises the steps of:
a) letting the user either select objects from a predefined list or define the geometry of one or more objects; and
b) presenting the select objects visually for the user.

In an embodiment, the user defines how the geometry and/or position or orientation of the one or more objects varies as a function of time.

In an embodiment, the method comprises the steps of:
a) detecting stationary obstacles or moving obstacles using one or more sensors; and
b) applying the data collected by the one or more sensors to carry out the optimization process.

In an embodiment, the method comprises the step of:
a) connecting one or more extension modules to the control unit, wherein the one or more extension modules comprise information related to one or more pieces of hardware, wherein said information includes data that defines the geometry and optionally other properties (configuration, orientation or version) of the one or more pieces of hardware.

Each of the extension modules is pre-programmed with one or more applications. Each of the extension modules is configured to enable the user to provide specific application inputs in order to ease the programming. The specific application inputs may be related to the type and position of conveyors, sensors, pick and place points.

The control unit (e.g., a compute box) and/or one or more of the extension modules are configured to provide collision avoidance of objects in the application environment.

In an embodiment, the method comprises the step of moving the tool from the starting point to the end point.

The control system according to the invention is a control system configured to generate a path for a robot arm and a tool attached to the robot arm, wherein the robot arm is placed in a workspace that can comprise obstacles, wherein the robot arm is connected to a control unit that is configured to control the motion of the robot arm, wherein the path has a starting point and an end point, wherein the path is composed of a plurality of sub-motions, wherein the control system is configured to create the path as a single consecutive motion, wherein the path is a collision free path, wherein the i-th sub-motion is determined by an optimization process carried out on the basis of predefined characteristics of:
a) the previous sub motion;
b) the workspace and its obstacles if any;
c) the tool; and
d) the robot arm.

Hereby, it is possible to generate the path in an easier and more user-friendly manner than in the prior art. Accordingly, it is possible to reduce the programming time. Moreover, the programming does not require skilled personnel as in the prior art.

In an embodiment, the control system is configured to let a user select a relevant application from a list of predefined applications each having predefined characteristics. The selection may be accomplished through a human machine interface.

In an embodiment, the control system is configured to autodetect a relevant application from a list of predefined applications each having predefined characteristics.

In an embodiment, the i-th sub-motion is determined by an optimization process carried out on the basis of predefined characteristics of the configuration of the tool and the robot arm, wherein the configuration includes the orientation, position and geometry of the tool, wherein the configuration of the tool is being monitored.

In an embodiment, the control system is configured to receive user input with instructions defining a number of two-or three-dimensional zones, including one or more safety zones, in which the speed of the robot arm and/or the tool has to be reduced, wherein the control system is configured to:
a) determine when the robot arm and/or the tool is within one or more safety zones; and
b) reduce the speed of the robot arm and/or the tool to a predefined level.

In an embodiment, the control system is configured for generating a completed robot program with a path for a robot arm to move along.

In an embodiment, the control system is configured to generate the robot program in dependency of sensory input conditions.

In an embodiment, the control system is configured to generate the robot program in dependency of peripheral machine actuation statements.

In an embodiment, the control system is configured to take into consideration the state of the workpiece (present or not, to be gripped or placed).

In an embodiment, the control system is configured to determine the i-th sub-motion by an optimization process carried out on the basis of:
the configuration of the tool, wherein the configuration includes the orientation, position and geometry of the tool, and the state (if a workpiece is present or not), wherein the configuration of the tool is being monitored; and
the predefined characteristics of the selected application.

In an embodiment, the optimization process is carried out in a control unit of the control system.

In an embodiment, the optimization process is carried out in a compute module of the control system.

In an embodiment, the optimization process is carried out in a compute module of a control unit of the control system.

In an embodiment, the control system is configured to change the configuration of the tool while the robot arm is moved, e.g., in dependency of one or more sensor signals and/or camera signals.

Carrying out a change of the configuration of the tool may include preparing the tool for an upcoming tool action.

In an embodiment, the tool is a gripper and the control system is configured to open the gripper so that it is ready to grip an object while moving the gripper towards an object to be gripped by the gripper. This may be done when the position of the object is known or detected, e.g., by a sensor or a camera.

In an embodiment, the control system is configured to:
a) determine the position and/or configuration of an object or structure in the workspace; and
b) provide an adaptive control by determining the path in dependency of the basis of the position and/or configuration of an object or structure.

If a robot is feeding objects to two pallets in an alternating manner and suddenly one of the pallets is removed, the robot will continue to feed objects to the remaining pallet.

In an embodiment, the control system is configured to carry out real time (online) data collection and data processing, wherein the data collection includes determination of position data of objects and structures.

In an embodiment, the control system is configured to save historical data of the motion of the robot arm, the tool and the objects handled by the tool so that the position of the objects relative to the robot arm are saved.

Hereby, it is possible to move the robot and corresponding structures (e.g., pallets), for example, to another location and continue the process (e.g., feeding objects to a pallet).

In an embodiment, the control system is configured to carry out an initial hardware setup step that is carried out by a user before the control system carries out the optimization process, wherein the control system comprises a control module, by which the user can select one or more pieces of hardware including the robot arm during the setup step.

In an embodiment, the control module is configured to:
a) automatically detect the one or more pieces of hardware that is wired or wirelessly connected to the control unit;
b) present the detected pieces of hardware visually for the user;
c) let the user confirm the automatically detected pieces of hardware; and
d) let the user select additional pieces of hardware from a predefined list.

In an embodiment, the control module is configured to enable an initial workspace setup step carried out by the user before the control system performs the optimization process, by which control module:
a) the position and orientation of the selected pieces of hardware in the workspace setup step can be selected;
b) the selected pieces of hardware can be inserted into the workspace; and
c) the selected pieces of hardware can be visually presented for the user.

In an embodiment, the control module is configured to enable an initial obstacle setup step carried out by a user before carrying out the optimization process, by which control module:
a) the user can either select objects from a predefined list or define the geometry of one or more objects; and
b) the select objects can be visually presented for the user.

In an embodiment, the control module is configured to enable the user to define how the geometry and/or position or orientation of the one or more objects varies as a function of time.

In an embodiment, the control module is configured to:
a) detect stationary obstacles or moving obstacles using one or more sensors; and
b) apply the data collected by the one or more sensors to carry out the optimization process.

In an embodiment, the control module comprises one or more connection structures arranged and configured to receive and hereby electrically connect one or more additional boxes to the control unit, wherein the one or more additional boxes comprise information related to one or more pieces of hardware, wherein said information includes data that defines the geometry and optionally other properties (configuration, orientation and/or version) of the one or more pieces of hardware.

In an embodiment, the control module is integrated in the control unit.

In an embodiment, the control unit constitutes the control module.

In an embodiment, the control system is configured to initiate and control the motion of the tool from the starting point to the end point.

In an embodiment, the path is generated automatically in such a manner that sharp turns are avoided by blending (corner rounding) the sharp corner sections. Hereby, it is possible to avoid unnecessary accelerations and decelerations of the robot arm and thus enable faster cycle times.

In an embodiment, the blending is established by letting the user define a blending point and a corresponding blending radius.

### BRIEF DESCRIPTION OF THE DRAWINGS

The systems and methods will become more fully understood from the detailed description given herein below. The accompanying drawings are given by way of illustration only, and thus, they are not limitative. In the accompanying drawings:

FIG. 1 shows a schematic view of a control system according to an embodiment;

FIG. 2 shows how a path for a robot arm and a tool attached to the robot arm is generated by using a prior art control system;

FIG. 3 shows a flowchart of the present method according to an embodiment;

FIG. 4 shows another flowchart of the present method according to an embodiment;

FIG. 5A shows an example of how the workspace is defined using the method according to an embodiment;

FIG. 5B shows an example of how obstacles are added to the workspace using the method according to an embodiment;

FIG. 6 shows how devices are automatically detected and/or manually added during a hardware setup of a method according to an embodiment;

FIG. 7A shows a schematic view of a control system according to an embodiment;

FIG. 7B shows the control system shown in FIG. 7A in another configuration; and

FIG. 8 shows a control system according to an embodiment.

### DETAILED DESCRIPTION

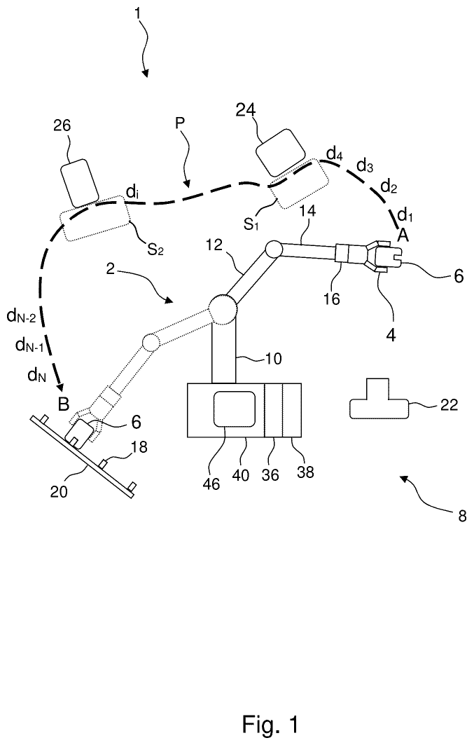

FIG. 1 is a schematic side view of a control system 1 according to an embodiment. The control system 1 is configured to generate a path P for a robot arm 2 and a tool 4 attached to the robot arm 2. The robot arm 2 is placed in a workspace 8 that comprises several obstacles 22, 24 26 placed in different locations in the workspace 8. The robot arm 2 comprises a base 10, a distal arm member 14 and an intermediate arm member 12 extending therebetween. A connector 16 is provided at the distal end of the distal arm member 14. The connector 16 is configured to couple a tool 4 to the robot arm 2. The tool 4 attached to the robot arm 2 is a gripper 4.

The robot arm 2 is cobot that is connected to a control unit (designed as a compute box) 40. The compute box 40 is configured to control the motion of the robot arm 2.

The path P has a starting point A and a different end point B. In an embodiment, the starting point A, however, can correspond to the end point B. In FIG. 1, the end point B corresponds to a position, in which the object 6 is placed on a board 20. In fact, the object 6 is placed on a pin 18 protruding from a surface of the board 20.

The path P is composed by a plurality of sub-motions d₁, d₂, d₃, . . . , d_{N-1}, d_{N}.

The control system 1 is configured to let a user select a relevant application from a list of predefined applications each having predefined characteristics. Hereby, the control system 1 can define restrictions as well as task or work goals related to the characteristics of the selected application.

The control system 1 is configured to enable both the option of applying user inputs (application related information such as selecting a relevant application from a list) and autodetection of hardware such as the tool 4 and the robot arm 2. Hereby, the application is loaded into the system.

The control system 1 is configured to create the path P as a single consecutive motion, wherein the i-th sub-motion dᵢ is determined by an optimization process carried out on the basis of predefined characteristics.

The optimization process is carried out on the basis of predefined characteristics of:
a) the predefined characteristics of the selected application;
b) the previous sub motion dᵢ₋₁;
c) the workspace 8 and its obstacles 22, 24, 26;
d) the dynamic configuration of the tool 4 and the robot arm 2;
e) the robot arm 2.

The configuration of the tool 4 includes the orientation, position and geometry of the tool 4. The configuration of the tool 4 is being monitored.

A first safety zone S₁ and a second safety zone S₂ are defined by the user. In these safety zones S₁, S₂ the speed of the robot arm 2 is restricted to a predefined level that is lower than the allowed speed level in the remaining zones of the workspace 8. The safety zones S₁, S₂ are defined as two-dimensional or three-dimensional zones.

The first safety zone S₁ is placed adjacent to the obstacle 24, while the second safety zone S₂ is placed adjacent to the obstacle 26.

A first extension module 36 and a second extension module 38 have been electrically connected to the compute box 40.

Each of the extension modules 36, 38 comprises information related to one or more pieces of hardware such as the robot arm 2 and the tool 4 (a griper). The information related to one or more pieces of hardware includes data that defines the geometry and optionally other properties (configuration, orientation or version) of the one or more pieces of hardware.

In the prior art, the robot arm is not aware of dimensions of the tool. Accordingly, even though the robot arm monitors its own motion, there is a risk of collision between the tool and structures in the workspace.

If a mistake is made by the user during the initial setting of the control system 1, the control system 1 can perform an auto fault detection and hereby detect that something is wrong. The control system 1 can carry out an auto fault detection if a gripper is setup with too long (e.g., 1 m) of a fingertip. The auto fault detection then allows a re-check enabling the user to correct the mistake.

In an embodiment, the auto fault detection function is integrated into the computer box 40. In an embodiment, the auto fault detection function is integrated into one or more of the extension modules 36, 38.

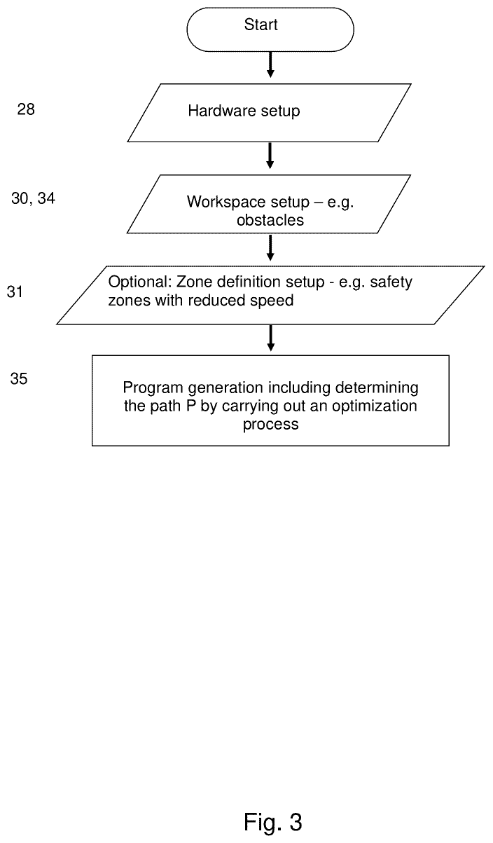

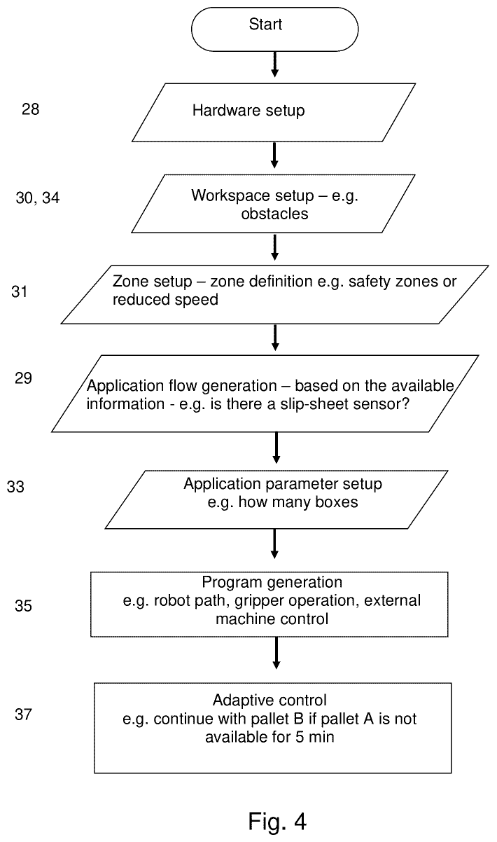

The control system 1 comprises a control module 46, by which the user can select one or more pieces of hardware 4, 22 including the robot arm 2 during the setup step (shown in and explained with reference to FIG. 3 and FIG. 4).

In an embodiment, the control module 46 is configured to:
a) automatically detect the one or more pieces of hardware 2, 4 that is wired or wirelessly connected to the compute box 40;
b) present the detected pieces of hardware 2, 4 visually for the user;
c) let the user confirm the automatically detected pieces of hardware 2, 4; and
d) let the user select additional pieces of hardware from a predefined list.

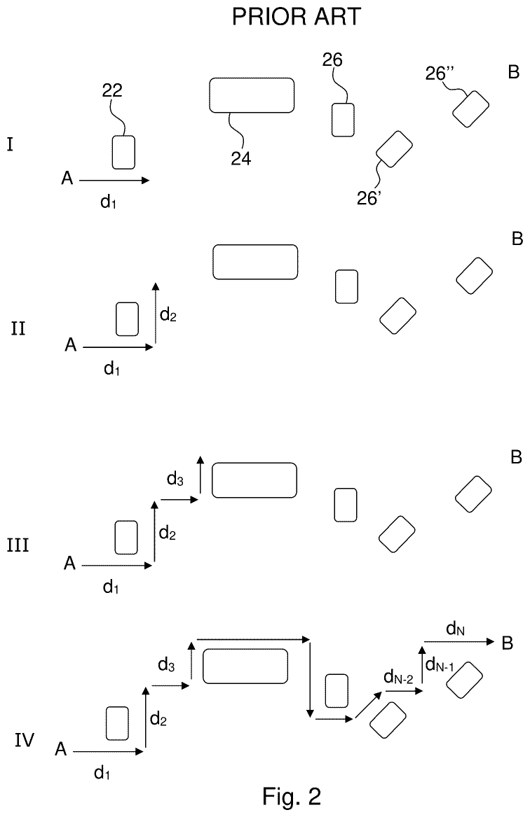

FIG. 2 illustrates a top view of how a path for a robot arm and a tool attached to the robot arm is generated using a prior art control system. The path has a starting point A and a different end point B.

In the first step I, a first sub-motion d₁ is calculated on the basis of the available information. The robot arm calculates a horizontal sub-motion d₁ in which the robot arm and a tool attached to the robot arm pass by an obstacle 22. The workspace, in which the path is generated comprises several obstacles 22, 24, 26, 26′.

In the second step II, a second sub-motion d₂ is calculated on the basis of the available information. The robot arm calculates a horizontal sub-motion d₂ in which the robot arm and a tool attached to the robot arm pass by an obstacle 22. The second sub-motion d₂ extends perpendicular to the first sub-motion d₁.

In the third step III, a third sub-motion d₃ is calculated on the basis of the available information. The third sub-motion ds extends perpendicular to the second sub-motion d₂.

In the fourth step IV, the remaining sub-motions d_{N-2}, d_{N-1}, d_{N} are illustrated. It can be seen that the prior art method for generating the path includes generation of a plurality of single sub-motions d₁, d₂, d₃, . . . , d_{N-2}, d_{N-1}, d_{N} one by one.

FIG. 3 illustrates a flowchart of the method according to an embodiment. When the method has been initiated in the first step “Start” the next step is a hardware setup step 28, in which the hardware of the control system is setup. During the hardware setup the user can manually select one or more pieces of hardware. It is also possible to conduct an automatic detection and hereby add automatically detected hardware in the control system. As the tools are typically electrically connected to the robot arm or the compute box, the wired connections allow an autodetection to be carried out.

During the hardware setup step, the hardware connected will be visualized for the user. The user may amend any characteristics of the hardware if desired. The user can define the hardware and any characteristics of the hardware if required. The user may, by way of example, select standard fingertips of a gripper. Alternatively, the user may create new settings and, for example, amend the length of the gripper or the fingertips.

The next step is a workspace setup step 30. In the workspace setup step 30, the area that the robot can reach is defined. During the workspace setup step 30, any obstacles can be defined in an optional obstacle setup step 34. The robot arm itself is considered as an obstacle.

Once the hardware setup 28 has been carried out and the parameters are setup, the user needs to define the workspace. In an embodiment, the method comprises a user guide feature configured to guide the user. In an embodiment, the application is palletizing, and the user guide is designed to guide the user to setup the palletizing application.

The method comprises an optimal zone definition setup 31 that is indicated below the workspace setup step 30. In the zone definition setup step 31 it is possible to setup safety zones, such as the one shown in and explained with reference to FIG. 1. In an embodiment, the geometry, orientation, size and position of the safety zones are defined by the user during the zone definition setup step 31. In an embodiment, geometry, orientation, size and position of the safety zones are selected from a list comprising a number of predefined characteristics (geometry, orientation, size and position). The safety zones are defined as two-dimensional or three-dimensional zones.

In an embodiment, the safety zones are selected, such as the one shown in and explained with reference to FIG. 1. In an embodiment, the safety zones are defined by the user in such a manner that the speed of the robot arm 2 is restricted to a predefined level that is lower than the allowed speed level in the remaining zones of the workspace.

The next step is a program generation step 35. In the program generation step 35 the path is determined. The determination is carried out through an optimization. The optimization is carried out in such a manner that the path is created as a single consecutive motion. This means that the path is created so it results in a continuous motion.

The i-th sub-motion is determined by an optimization process carried out on the basis of:
a) the predefined characteristics of the selected application;
b) the previous sub motion;
c) the workspace and its obstacles if any;
d) the dynamic configuration of the tool and the robot arm, wherein the configuration includes the orientation, position and geometry of the tool, wherein the configuration of the tool is being monitored;
e) the robot arm.

By letting the user select a relevant application from a list of predefined applications each having predefined characteristics, it is possible to automatically take into account any relevant characteristics of the tool, the robot arm, obstacles and other pieces of hardware. Accordingly, the methods disclosed herein make it possible to generate the program required to use the robot arm without carrying out complex and time consuming programming that requires skilled personnel. The methods enable a more user-friendly, faster and less complex way of creating the program required to use the robot arm.

FIG. 4 illustrates another flowchart of a method according to an embodiment. The first three steps (Start, hardware setup step 28 and workspace setup step 30 with the optimal obstacle setup step 34) correspond to the one shown in and explained with reference to FIG. 3.

After the third step, a fourth application flow generation step 29 is carried out. In the application flow generation step 29, a flow is generated in dependency of the available information. By way of example, the available information may include information about the presence of a slip-sheet.

In an embodiment, the application comprises a CNC processing process. In this embodiment, the application flow generation step 29 may comprise the following steps:
Pickup an object from an infeed;
Load the object into the CNC machine;
Upload the machined object from the CNC machine;
Place the machined object into an outfeed.

In an embodiment, the application flow generation step 29 includes application of information provided in and accessible from one or more extension modules that are electrically connected to the control box (e.g., a compute box).

After the fourth step 29, a fifth application parameter setup step 33 is carried out. In the application parameter setup step 33, one or more parameters are setup. In the application parameter setup step 33, a parameter such as the number of boxes to be processed may be defined. Moreover, the position, size, geometry and orientation of the boxes may be defined by the user in this step. In an embodiment, the parameters are selected from a predefined list by the user.

After the fifth step 33, a sixth program generation step 35 is carried out. This step corresponds to the program generation step 35 shown in and explained with reference to FIG. 3.

After the sixth program generation step 35, an adaptive control step 37 is carried out. In the adaptive control step 37, an adaptive control is carried out on a regular and continuous basis. The adaptive control step 37 is carried out in dependency of monitored or provided information.

In one example, several pallets are available for receiving processed objects. If one or more of the pallets is not available for predefined time period (e.g., 5 minutes), another pallet is applied instead of the missing pallet. Hereby, the method is able to optimize the procedures on a continuous basis based on the actual state and configuration of the structures in the workspace.

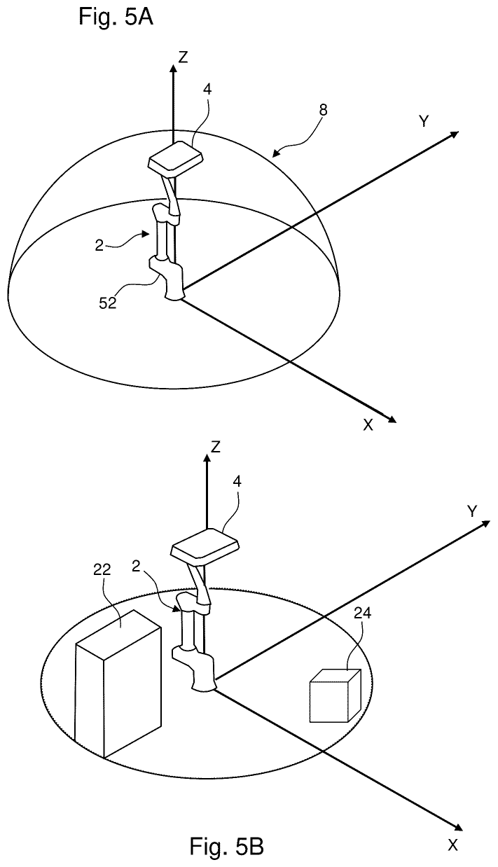

FIG. 5A illustrates an example of how the workspace 8 is defined using a method according to an embodiment. FIG. 5B illustrates an example of how obstacles 22, 24 are added to the workspace 8 using a method according to an embodiment.

In an embodiment, the visualization shown in FIG. 5A and FIG. 5B may be shown on a display integrated in or connected to a control module like the one shown in and explained with reference to FIG. 4.

A robot arm 2 is placed in the workspace 8. The robot arm 2 is mounted on a base 52. A tool 4 is attached to the robot arm 2. The workspace 8 is defined by a

Cartesian coordinate system comprising an X axis, a Y axis and a Z axis.

In FIG. 5B a user has added a first obstacle 22 and a second obstacle 24 to the workspace 8. The obstacles 22, 24 are box-shaped. However, the obstacles 22, 24 may have other geometries. In an embodiment, the control system and the method according to an embodiment is configured to enable the user to add obstacles and select their geometry, size, orientation and position relative to the Cartesian coordinate system.

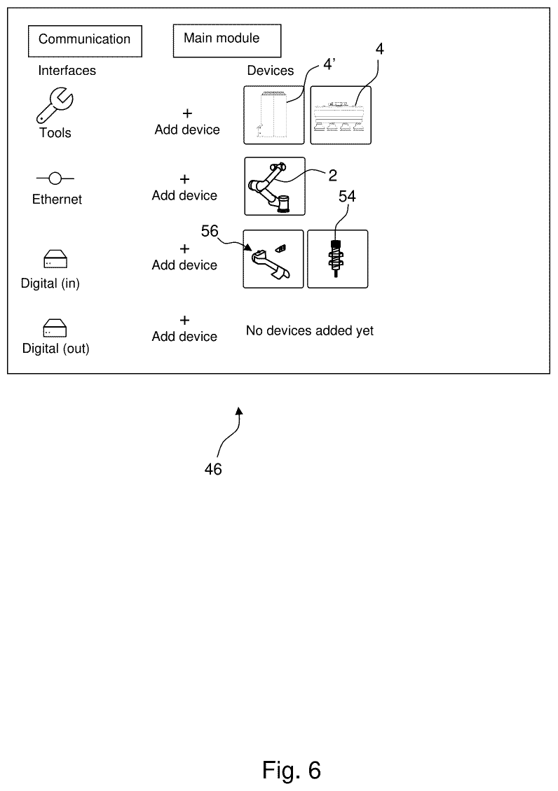

FIG. 6 illustrates how devices are automatically detected and/or manually added during a hardware setup of a control system or a method. In an embodiment, the visualization shown in FIG. 6 is shown on a display integrated in or connected to a control module like the one shown in and explained with reference to FIG. 4.

It can be seen that during the hardware setup a vacuum gripper 4 and a lift (a robot elevator) 4′ have been selected.

A robot arm 2 has been autodetected. By connecting one or more extension modules that comprise information related to one or more pieces of hardware, it is possible to provide information about the devices 54, 56 that are added by the user. In FIG. 6, the devices are an automatic pallet station 56 and an infeed sensor 54.

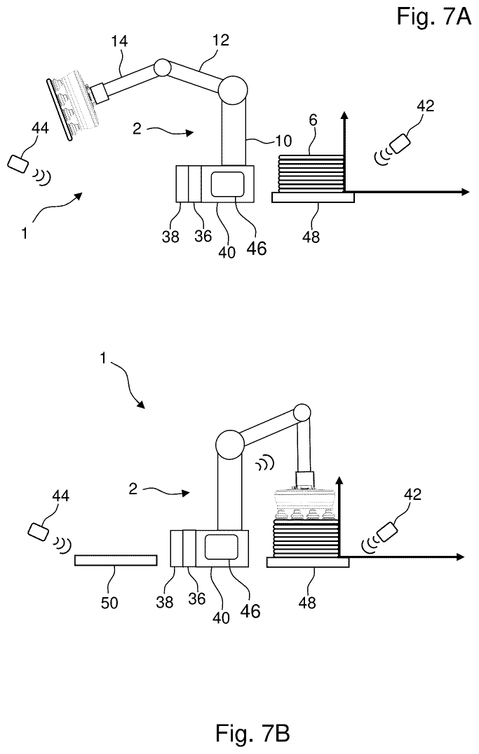

FIG. 7A illustrates a schematic view of a control system 1 according to an embodiment and FIG. 7B illustrates the control system shown in FIG. 7A in another configuration.

The control system 1 comprises a robot arm 2 corresponding to the one shown in and explained with reference to FIG. 1. The robot arm 2 comprises a base 10, a distal arm member 14 and an intermediate arm member 12 extending therebetween. A tool (a vacuum gripper) is attached to the robot arm 2. The vacuum gripper is used to stack plate-shaped objects 6 on a first pallet 48 and a second pallet 50.

The control system 1 comprises a compute box 40 and two extension modules 36, 38 that are electrically connected to the compute box 40. The control system 1 comprises a first sensor 42 arranged and configured to detect the presence of the first pallet 48. The control system 1 comprises a second sensor 44 arranged and configured to detect the presence of the second pallet 50.

In FIG. 7A the second sensor 44 will detect that the second pallet 50 is missing. Accordingly, the control system 1 will ensure that all objects 6 are stacked on the first pallet 48 only.

In FIG. 7B, however, the second sensor 44 will detect that the second pallet 50 is present. Accordingly, the control system 1 will allow the robot arm 2 to stack objects 6 on the second pallet 50.

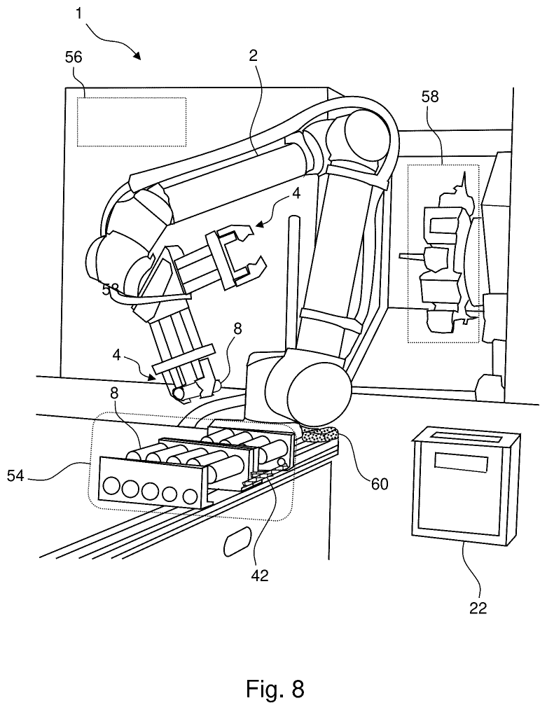

FIG. 8 illustrates a control system 1 according to an embodiment. The control system 1 is configured to generate a path for a robot arm 2 to move along with a tool (a gripper) 4 attached to the robot arm 2.

The robot arm 2 is placed in a workspace (a robot cell) 8 that can comprise an obstacle 22. The robot arm 2 is connected to a control unit that is designed as control module 60 that is configured to control the motion of the robot arm 2.

In this example a completed robotic program is generated. The generated program will, during start-up, check the status of an infeed sensor 42. If parts are not present it will provide user feedback to fill the infeed tray. When objects 6 have been added it will await confirmation from the user. The control system 1 may comprise a display 62 configured to present information to a user in order to provide user feedback. The user may utilize the display 62 (e.g., formed as a touch screen) to confirm that the infeed tray has been filled.

The robotic program is configured to check if the door 56 of a CNC machine is open. If the door 56 is not open, the program will send a command to the CNC machine that will open the door 56 upon receiving this command. The program now advances to the infeed area and picks a new object 6. The gripping distance is known from the workpiece geometry. If the gripper 4 for some reason fails to grip the object 8, the program will stop with an error message. The robot arm 2 now follows the generated path avoiding self-collisions (workpiece/gripper 4 hitting robot parts), the door opening and the tool changer inside the CNC machine. It grasps a machined part from the machine, turns the robot-end-effector around, inserts a new workpiece for the machine to work on and retracts. A command to close the machine door 56 is sent and the CNC machine is commanded to start task execution. This represents one full machine cycle.

### LIST OF REFERENCE NUMERALS

1 Control system
2 Robot arm
4, 4′ Tool
6 Object
8 Workspace
10 Base
12 Intermediate arm member
14 Distal arm member
16 Connector
18 Pin
20 Board
22, 24 Obstacle
26, 26′, 26″ Obstacle
28 Hardware setup step
29 Application flow generation step
30 Workspace setup step
31 Zone setup step
32 Hardware
33 Application parameter setup step
34 Obstacle setup step
35 Program generation step
36 First extension module
37 Adaptive control step
38 Second extension module
40 Compute box
42, 44 Sensor
46 Control module
48,50 Structure (e.g. a pallet)
52 Base
54 Infeed device
56 Door
58 Machine member
60 Compute module
P Path
A Starting point
B End point
d₁, d₂, d₃, d₄, . . . , dᵢ₋₁, Sub-motion
dᵢ₊₁, d_{N-2}, d_{N-1}, d_{N} Sub-motion
dᵢ The i-th sub-motion
S₁, S₂ Safety zone
X, Y, Z Axis

1. A method for generating a path (P) for a robot arm to move along with a tool attached to the robot arm, the tool arranged to handle or process an object, the robot arm placed in a workspace that comprises one or more obstacles, wherein the robot arm is connected to a control unit that is configured to control the motion of the robot arm, wherein the path (P) has a starting point (A) and an end point (B) and is composed of a plurality of sub-motions (d₁, d₂, d₃, . . . , d_{N-2}, d_{N-1}, d_{N}), the method comprising:
selecting a relevant application from a list of predefined applications each having predefined characteristics;
creating the path (P) as a single consecutive motion, wherein the path (P) is a collision free path (P) and an i-th sub-motion (dᵢ) is determined by an optimization process carried out on the basis of:
a) a previous sub motion (dᵢ₋₁);
b) the workspace and the one or more obstacles;
c) a configuration of the robot arm; and
d) the robot arm,
wherein the i-th sub-motion (dᵢ) is determined by the optimization process carried out on the basis of:
a configuration of the tool including an orientation, position and geometry of the tool, wherein the configuration of the tool is monitored; and
the predefined characteristics of the relevant application.

2. The method according to claim 1, wherein the step of selecting the relevant application is performed by auto detecting.

3. The method according to claim 1, further comprising carrying out a change of the configuration of the tool while the robot arm is moved.

4. The method according to claim 1, further comprising:
a) determining a position and/or configuration of an object or structure in the workspace; and
b) providing an adaptive control by determining the path (P) in dependency of the position and/or configuration of the object or structure.

5. The method according to claim 1, further comprising an initial hardware setup step comprising selecting one or more pieces of hardware including the robot arm.

6. The method according to claim 5, further comprising an initial workspace setup step comprising:
a) selecting a position and orientation of selected obstacles;
b) inserting selected hardware into the workspace; and
c) presenting the selected hardware visually for a user.

7. The method according to claim 1, further comprising the steps of:
a) detecting stationary obstacles or moving obstacles using one or more sensors; and
b) applying data collected by the one or more sensors to carry out the optimization process.

8. The method according to claim 1, further comprising the step of defining a number of two-or three-dimensional zones, including one or more safety zones (S₁, S₂), in which a speed of the robot arm and/or the tool has to be reduced.

9. The method according to claim 1, further comprising the steps of:
a) connecting one or more extension modules to the control unit, wherein the one or more extension modules comprise information related to one or more pieces of hardware, wherein said information includes data that defines one or more of the geometry, configuration, orientation and version of the one or more pieces of hardware.

10. A control system configured to generate a path (P) for a robot arm to move along with a tool attached to the robot arm, wherein the robot arm is placed in a workspace that comprises obstacles and the robot arm is connected to a control unit that is configured to control motion of the robot arm, wherein the path (P) has a starting point (A) and an end point (B) and is composed of a plurality of sub-motions (d₁, d₂, d₃, . . . , d_{N-2}, d_{N-1}, d_{N}), wherein the control system is configured to create the path (P) as a single consecutive motion, wherein the path (P) is a collision free path (P), wherein an i-th sub-motion (dᵢ) is determined by an optimization process carried out on the basis of predefined characteristics of:
a) a previous sub motion (dᵢ₋₁);
b) the workspace and the one or more obstacles; and
c) the robot arm,
wherein the i-th sub-motion (dᵢ) is determined by the optimization process carried out on the basis of:
predefined characteristics of the tool;
a configuration of the tool and the robot arm comprising an orientation, position and geometry of the tool, wherein the configuration of the tool is monitored; and
the predefined characteristics of a relevant application.

11. The control system according to claim 10, wherein the control system is configured to change the configuration of the tool while the robot arm is moved.

12. The control system according to claim 10, wherein the control system is configured to:
a) determine a position and/or configuration of an object or structure in the workspace; and
b) provide an adaptive control by determining the path (P) in dependency of the position and/or configuration of the object or structure.

13. The control system according to claim 10, wherein the control system is configured to carry out an initial hardware setup step before the control system carries out the optimization process, wherein the control system comprises a control module that allows selection of one or more pieces of hardware including the robot arm during the initial hardware setup step.

14. The control system according to claim 13, wherein the control module is configured to:
a) automatically detect the one or more pieces of hardware that is/are wired or wirelessly connected to the control unit;
b) present the one or more pieces of hardware visually for a user;
c) receive confirmation of the automatically detected pieces of hardware; and
d) allow for selection of additional pieces of hardware from a predefined list.

15. The control system according to claim 14, wherein the control module is configured to enable an initial workspace setup step before the control system carries out the optimization process, wherein the control module:
a) provides positions and orientations of selected pieces of hardware in the workspace;
b) allows for insertion of the selected pieces of hardware into the workspace; and
c) visually presents the selected pieces of hardware to the user.

16. The control system according to claim 14, wherein the control module is configured to enable an initial obstacle setup step before carrying out the optimization process, wherein the control module:
a) allows for selection of objects from a predefined list or defines the geometry of one or more objects and how the geometry and/or position or orientation of the one or more objects varies as a function of time; and
b) visually presents the select objects to the user.

17. The control system according to claim 10, wherein the control module is configured to:
a) detect stationary obstacles or moving obstacles using one or more sensors; and
b) apply data collected by the one or more sensors to carry out the optimization process.

18. The control system according to claim 10, wherein the control system is configured to receive user input with instructions defining a number of two-or three-dimensional zones, including one or more safety zones (S₁, S₂), in which the speed of the robot arm and/or the tool has to be reduced, wherein the control system is configured to:
a) determine when the robot arm and/or the tool is within the one or more safety zones (S₁, S₂); and
b) reduce the speed of the robot arm and/or the tool to a predefined level.

19. The control system according to claim 10, wherein the control module comprises one or more connection structures arranged and configured to receive and electrically connect one or more additional boxes to the control unit, wherein the one or more additional boxes comprise information related to one or more pieces of hardware, wherein said information includes data that defines one or more of the geometry, configuration, orientation and version of the one or more pieces of hardware.

20. The control system according to claim 10, wherein the control system is configured to initiate and control the motion of the tool from the starting point (A) to the end point (B).
